(19) United States
(12) Patent Application Publication
(10) Pub. No.: US 2023/0294182 A1
(43) Pub. Date: Sep. 21, 2023

(54) Apparatus and Methods for Deburring a Hole

(71) Applicant: Hoffman Enclosures Inc., Anoka, MN (US)

(72) Inventors: Scott Stammer, Champlin, MN (US); Allen DeMars, Elk River, MN (US); La Her, Columbus, MN (US); John O. Buyse, Anoka, MN (US)

(21) Appl. No.: 18/185,790

(22) Filed: Mar. 17, 2023

Related U.S. Application Data
(60) Provisional application No. 63/320,746, filed on Mar. 17, 2022.

(51) Int. Cl. B23B 51/10

(52) U.S. Cl. CPC B23B 51/101

(57) ABSTRACT

A deburring tool for deburring a distal end of a bushing formed within a metal tube. The deburring tool can include a shaft extending along a shaft axis. The shaft can have a shaft distal end and a shaft proximal end. The deburring tool can also include a blade body extending radially outward from the shaft distal end. The blade body can have a cutting edge configured to engage the distal end of the bushing and remove material therealong.

### CROSS-REFERENCE TO RELATED APPLICATIONS

This application claims priority to U.S. Provisional Patent Application No. 63/320,746, filed Mar. 17, 2022, titled “Apparatus and Methods for Deburring a Hole,” the entirety of which is incorporated herein by reference.

### BACKGROUND

Certain drilling methods, for example, friction drilling or flow drilling, can be used to extrude material in thin wall tubes. This process forms a bushing protruding inside the tube. In some uses, the bushing can be tapped to provide a threaded port for receiving a threaded fitting. The process also forms burrs along the distal end of the bushing, which may result in debris intruding into the tube. Errant debris within a tube, for example, a liquid manifold, can contaminate the liquid within the manifold, clog flow passages and fittings, or cause other types of damage within a liquid distribution system.

### SUMMARY

Some embodiments of the invention can provide a deburring tool for deburring a distal end of a bushing formed within a metal tube. The deburring tool can include a shaft extending along a shaft axis. The shaft can have a shaft distal end and a shaft proximal end. A blade body can extend radially outward from the shaft distal end. The blade body can have a cutting edge configured to engage an external portion of the distal end of the bushing and remove material therealong.

Some embodiments of the invention can provide a deburring tool for use in a machining center for deburring a distal end of a bushing formed within a metal tube. The deburring assembly can include a base configured to be received in a tool holder of the machining center. A shaft can extend from the base along a shaft axis and can include a shaft distal end distal to the base and a shaft proximal end proximal to the base. A blade body can extend radially outward from the shaft distal end. The blade body can have a cutting edge configured to engage the distal end of the bushing and can be configured to remove material along an external portion of the distal end to define an external cut surface.

Some embodiments of the invention can provide a method for deburring a distal end of a bushing formed within a metal tube. The method can include translating a deburring tool in an insertion direction into the bushing. The deburring tool can have a shaft and a cutting edge, with an external cutting edge, radially extending from the shaft. The method can further include translating the deburring tool laterally, perpendicular to the insertion direction, a lateral distance within the bushing to position the shaft adjacent an internal surface of the bushing and the cutting edge over the distal end of the bushing. The deburring tool can then be translated in an extraction direction a predetermined distance and can engage the cutting edge with the distal end of the bushing. The deburring tool can them be translated around the distal end of the bushing to remove material from an external portion thereof with the external cutting edge of the cutting edge.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a top front right isometric view of a deburring tool according to an embodiment of the invention is provided;

FIG. 2 is a right side elevation view of the deburring tool of FIG. 1;

FIG. 3 is a left side elevation view of the deburring tool of FIG. 1;

FIG. 4 is front elevation view of the deburring tool of FIG. 1;

FIG. 4A is an enlarged detail view of a portion of the deburring tool of FIG. 4;

FIG. 5 is a rear elevation view of the deburring tool of FIG. 1;

FIG. 5A is an enlarged detail view of a portion of the deburring tool of FIG. 5;

FIG. 6 is a bottom plan view of the deburring tool of FIG. 1;

FIG. 7 is a top front left isometric view of an example tube with bushings from which a deburring tool according to an embodiment of the invention can remove burrs;

FIG. 8 is a top front right isometric view of another example tube with bushing from which a deburring tool according to an embodiment of the invention can remove burrs; and

FIGS. 9 through 13 are isometric and cross sectional views illustrating a method of deburring a bushing in a tube with the deburring tool of FIG. 1 according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Unless otherwise specified or limited, the terms “about” and “approximately,” as used herein with respect to a reference value, refer to variations from the reference value of ±10% or less (e.g., ±8, ±5%, ±3%, etc.), inclusive of the endpoints of the range.

Unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later connected together, is not an integral (or integrally formed) element.

Some of the discussion below describes a deburring tool that can be used to remove burrs from a bushing formed in a tube through a machining process (e.g., friction drilling). In some industries, for example data centers, a metal tube can be used as a manifold to deliver liquid through a liquid cooling system in an equipment rack. Liquid ports can be coupled to the manifold to feed branches of liquid cooling system. The liquid ports can include bushings that are formed in the thin wall sides of the manifold.

One method by which the bushings can be formed is friction drilling. Friction drilling is a method of making holes in metal in which a conical bit made from a high-heat-resistant material is spun and pressed through the metal to form a hole. The process is also called thermal drilling, flow drilling, form drilling, and friction stir drilling. Friction drilling does not remove material, instead it reforms the material into a bushing, or sleeve. The bushing can be tapped to provide a threaded port configured to receive a threaded fitting. The bushings after being formed, however, have a very jagged distal end with burrs. In liquid cooling systems, it is advantageous to deburr the bushing to reduce the potential for burrs breaking off and becoming debris that can clog ports within the manifold.

Conventional arrangements for deburring a bushing formed in a metal tube can include removal of material from the internal portion of the distal end of the bushing to create an internal cut surface. Other arrangements create a flat tip along the distal end of the bushing. Neither is sufficient for a flow-drilled bushing, however, because the entire distal end of the bushing is jagged and often full of burrs. Creating an internal cut surface and/or a flat tip along the distal end misses or only folds over burrs and excess material. This material is likely to erode in fluid flow through the metal tube/manifold, break off, and contaminate the liquid cooling system.

Embodiments of the invention can address these or other issues by helping to ensure burrs are fully removed from the distal end of a flow-drilled bushing. For example, in some embodiments, a deburring tool can be configured to remove material from an external portion of a flow-drilled bushing to remove burrs from an external portion of a flow-drilled bushing to remove burrs therefrom. In some embodiments, a deburring tool can be configured to remove material from an external portion and a distal edge of a flow-drilled bushing to remove burrs from the external portion and distal edge of the bushing. In some embodiments, a deburring tool can be configured to remove material from the external portion, the distal edge, and an internal portion of the distal end of a flow-drilled bushing to remove burrs around the entire distal end of the bushing. The deburring tool can include a blade body with a cutting edge configured to form at least an external cut surface. In some embodiments, the deburring tool can include a blade body with a cutting edge configured to form at least an external cut surface. In some embodiments the deburring tool can include a blade body with a cutting edge configured to form at least an external cut surface and a distal cut surface. In some embodiments, the deburring tool can include a blade body with a cutting edge configured to form an internal cut surface, an external cut surface, and a distal cut surface in the bushing. The removal of material from at least the external sides of the distal end of the bushing ensures removal of burrs thereon, instead of folding them over.

In some embodiments, the deburring tool can have a blade body with a cutting edge including at least one of an internal cutting edge, an external cutting edge, and a distal cutting edge to engage and remove material from at least one of the external, internal, and distal edge of the distal end of the bushing. In some embodiments, the cutting edge can have a V-shape profile, wherein the internal cutting edge and the external cutting edge represent the angled legs of the “V.” In some embodiments, the V-shape may be an asymmetrical V-shape. In other embodiments, the cutting edge can have a different profile shape, for example, a U-shape profile or a hook-like profile. In some embodiments, the cutting edge can be configured to make chamfered cuts, radiused cuts, or any other form of cut on any of the external cut surface, the internal cut surface, or the distal cut surface.

In some embodiments, the deburring tool can be configured to be received within a tool holder of a machining center. In some embodiments, the machining center can incorporate the deburring tool in a process for forming and finishing a hole in a metal tube. The deburring tool can be used in a process for removing burs from a distal end of a flow-drilled hole including being inserted within the bushing, engaging the distal end of the bushing, rotating around the bushing along the distal end, and removal from the bushing.

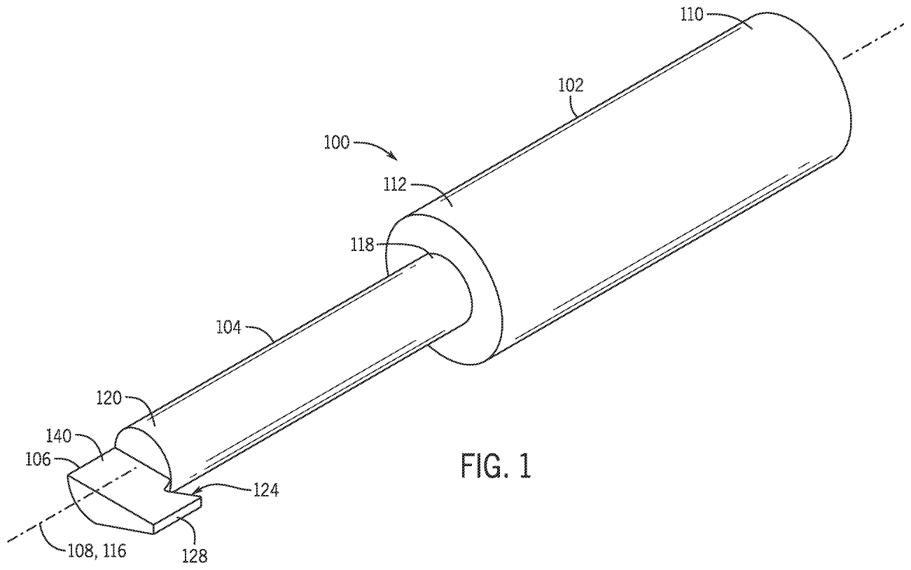

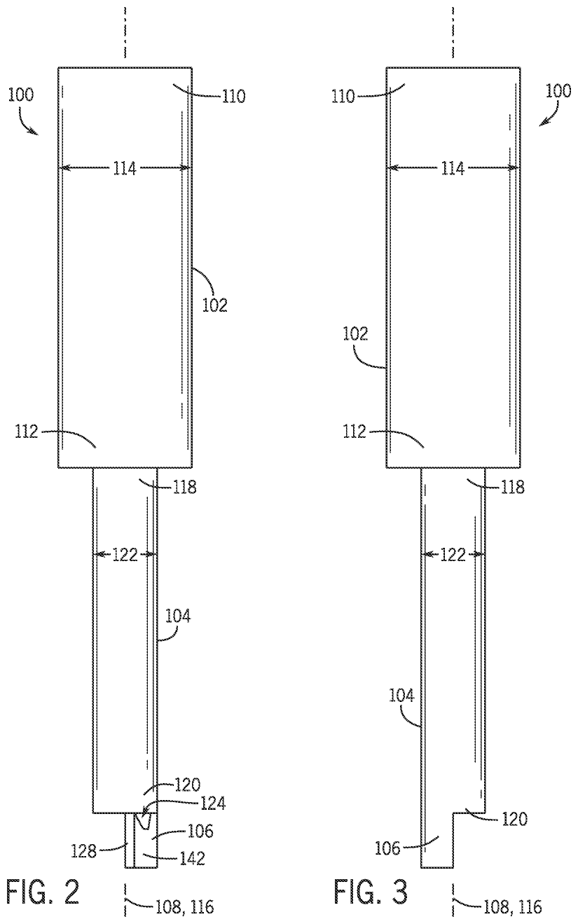

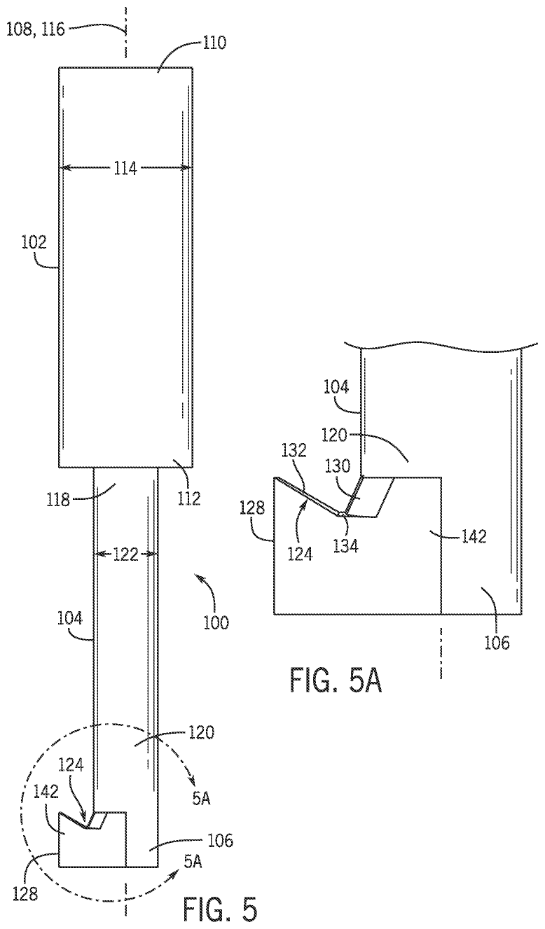

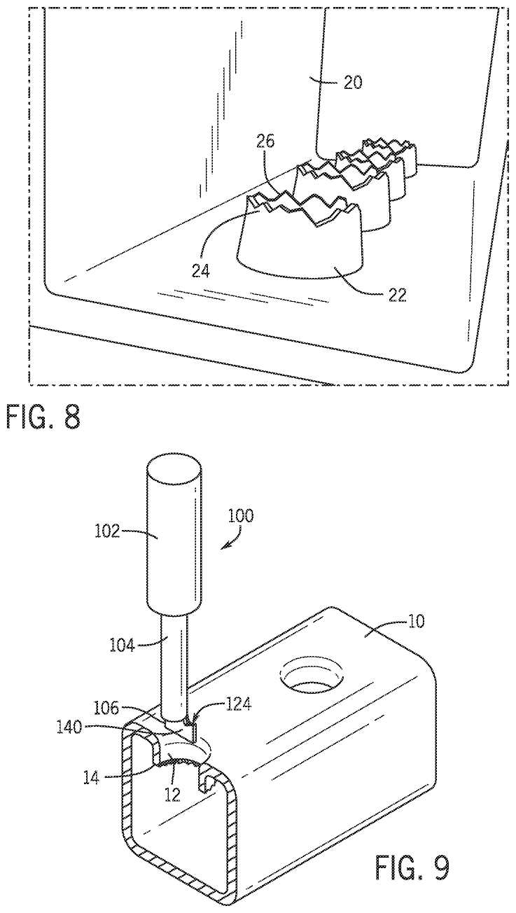

FIGS. 1 through 6 illustrate a deburring tool 100 according to an embodiment of the invention. The deburring tool 100 is configured to remove burrs from a distal end of a bushing formed in a tube through a machining process such as, for example, friction drilling. A pair of example tubes 10, 20 with bushings 12, 22 formed by friction drilling having distal ends 14, 24 with burrs 16, 18 are shown in FIGS. 7 and 8, respectively. Only the tube 10 shown in FIG. 7 will be discussed with respect to deburring, but the tube 20 provides an additional reference of a type of bushing with burrs that can be deburred with the deburring tool 100. As discussed above, in certain use cases, for example, with liquid transfer, it can be detrimental to other equipment within the liquid distribution system (not shown) if burrs 16 are left on the bushing 12 of a liquid manifold (e.g., the thin wall tube 10 with a square cross-section) after the bushing forming machining process is complete because the burrs 16 can break off and create debris that can travel within the system and block liquid ports or passageways. Therefore, it can be advantageous to have a tool that can remove burrs from at least the external sides (i.e., the external portion and the distal edge) of the distal end 14 of the bushing 12.

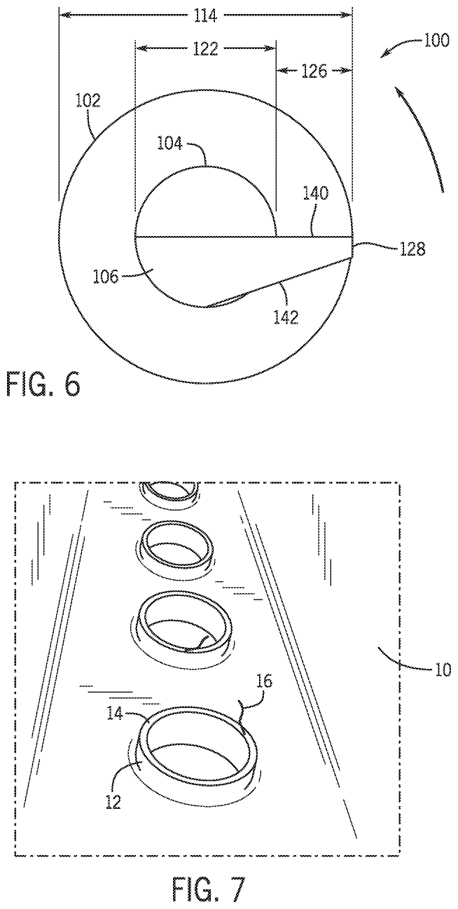

The deburring tool 100 is configured to remove material from at least the external portions of the distal end 14 of the bushing 12. The deburring tool 100 includes a base 102, a shaft 104, and a blade body 106. In some embodiments, the base 102 is cylindrically shaped, extending along a base axis 108 from a base proximal end 110 to a base distal end 112 and has a base diameter 114 (shown in FIG. 6). In some embodiments, the base 102 can be configured to be received within a tool holder of a machining center (not shown). The shaft 104 extends from the distal end 112 of the base 102. In some embodiments, the shaft 104 is cylindrically shaped, extending along a shaft axis 116 from a shaft proximal end 118 to a shaft distal end 120 and has a shaft diameter 122 (shown in FIG. 6). The base axis 108 is shown axially aligned with the shaft axis 116. However, in some embodiments, the base axis 108 can be offset from the shaft axis 116. Further, the shaft diameter 122 is smaller than the base diameter 114.

The blade body 106 is configured to extend over and engage with the distal end 14 of the bushing 12. The blade body 106 extends outward from the shaft distal end 120 along the direction of the shaft axis 116 and radially outward beyond the shaft 104 in one direction. For example, as shown with respect to the orientation of the deburring tool shown in FIG. 6, the blade body 106 extends radially outward along a 3'oclock direction. In some embodiments, the blade body 106 extends a blade distance 126, defined as the distance from the outer periphery of the shaft 104 to a blade distal end 128. In some embodiments, the blade distance 126 is equal to half the difference between the base diameter 114 and the shaft diameter 122. In this configuration, the deburring tool 100 can be formed from a single piece of round metal rod. In some configurations, as shown, the blade body 106 tapers as it extends from the shaft distal end 120 to the blade distal end 128.

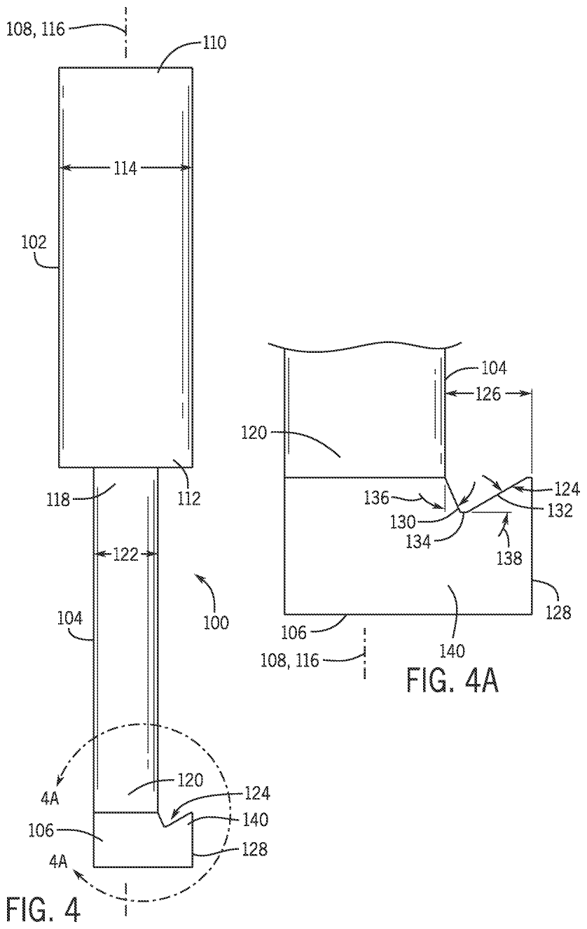

In some embodiments, as shown in FIGS. 4A, the blade body 106 can have a cutting edge 124 with a V-shape profile. However, as noted previously, in other embodiments, the cutting edge can have a different profile shape, for example, a U-shape profile or a hook-shaped profile. The cutting edge 124 faces in the direction of the shaft proximal end 118. The cutting edge 124 as shown has an internal cutting edge 130, an external cutting edge 132, and a distal cutting edge 134. The internal cutting edge 130 extends from or near the shaft 104 to the distal cutting edge 134. The distal cutting edge 134 extends between the internal cutting edge 130 and the external cutting edge 132. The external cutting edge 132 extends from the distal cutting edge 134 to or near the blade distal end 128. In some embodiments, however, the internal cutting edge 130 and the external cutting edge 132 can converge. In some embodiments, the cutting edge 124 can have only an external cutting edge 132 and a distal cutting edge 134.

In some embodiments, the internal cutting edge 130, the external cutting edge 132, and the distal cutting edge 134 can be disposed in predetermined orientations and angles with respect to each other and the shaft 104 to provide a desired profile of the distal end 14 of the bushing 12. For example, as shown in FIG. 4A, the internal cutting edge 130 is shown disposed from the shaft 104 at an internal cutting angle 136. In some embodiments, the internal cutting angle 136 can be in the range of about 20 degrees to about 30 degrees from the shaft axis 116. In some embodiments, the internal cutting angle 136 can be about 25 degrees. In some embodiments, the distal cutting edge 134 can be oriented perpendicular with respect to the shaft axis 116. However, in other embodiments, the distal cutting edge 134 can be disposed at an external cutting angle other than 90 degrees from the shaft axis 116. The external cutting edge 132 is disposed from the distal cutting edge 134 at an external cutting angle 138. In some embodiments, the external cutting angle 138 can be in the range of about 25 degrees to about 35 degrees relative to the distal cutting edge 134 or in the range of about 55 degrees to about 65 degrees relative to the shaft axis 116. In some embodiments, the external cutting angle 138 can be about 30 degrees relative to the distal cutting edge 134 or about 60 degrees from the shaft axis 116.

The cutting edge 124 is configured to remove burrs 16 the distal end 14 of the bushing 12 (e.g., the internal and external portions of the distal end 14) by engaging the internal, external, and free-end top of the distal end 14 of the bushing 12. The blade distance 126 is therefore configured to be larger than a thickness of the bushing 12. With respect to the V-shape configuration of the cutting edge 124 as shown, the internal cutting edge 130, the external cutting edge 132, and the distal cutting edge 134 of the cutting edge 124 are configured to define three cut surfaces of the distal end 14 of the bushing 12, including an internal cut surface, an external cut surface, and a distal cut surface, respectively. In some embodiments in which the internal cutting edge 130 and the external cutting edge 132 converge, the cutting edge 124 is configured to define two cut surfaces of the distal end 14 of the bushing 12, including an internal cut surface and an external cut surface. In other configurations, other resulting cut surface arrangements can occur. For example, if a U-shape cutting edge is used, the cut surface can also be U-shaped having one continuous, rounded, cut surface. All embodiments, however, remove material from the external portion of the distal end 14 of the bushing 12. Removing material from the external portion of the distal end 14 of the bushing 12 reduces the likelihood that the burrs 16 would be bent over but not removed. Bent-over burrs can detach and become debris within the tube 10 and create fluid flow blockage issues as discussed previously.

The deburring tool 100 is configured to rotate within the bushing 12 and around the distal end 14 in a deburring direction (illustrated by the arrows in FIGS. 6 and 13). The blade body 106 has a forward facing blade surface 140 and a rearward facing blade surface 142 when rotating in the deburring direction. In some embodiments, as shown in FIG. 6, the forward facing blade surface 140 is planar and lies along a plane with a first dimension extending along the shaft axis 116 and a second dimension extending perpendicular to the shaft axis 116. However, the forward facing blade surface 140 can be non-planar (e.g., concave) or can lie along a plane in which the first dimension is disposed at angle other than 0 degrees with respect to the shaft axis 116. The rearward facing blade surface 142, as shown in FIG. 6, can also be planar. The rearward facing blade surface 142 can extend from the peripheral surface of the blade body 106 toward the forward facing blade surface 140 at an oblique angle relative to a plane oriented perpendicularly from the forward facing blade surface 140 and extending from the shaft axis 116 to the peripheral surface of the blade body 106. In some embodiments, the rearward facing blade surface 142 may lie along a plane that is parallel with the plane along which the forward facing blade surface 140 lies. In some embodiments, the rearward facing blade surface 142 can be nonplanar (e.g., convex). In some embodiments, the rearward facing blade surface 142 can have both non-planar and planar sections.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

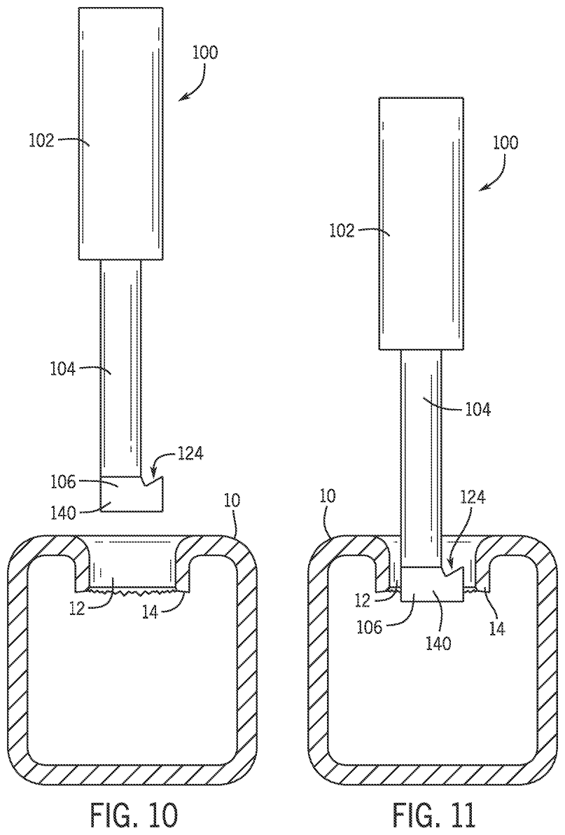

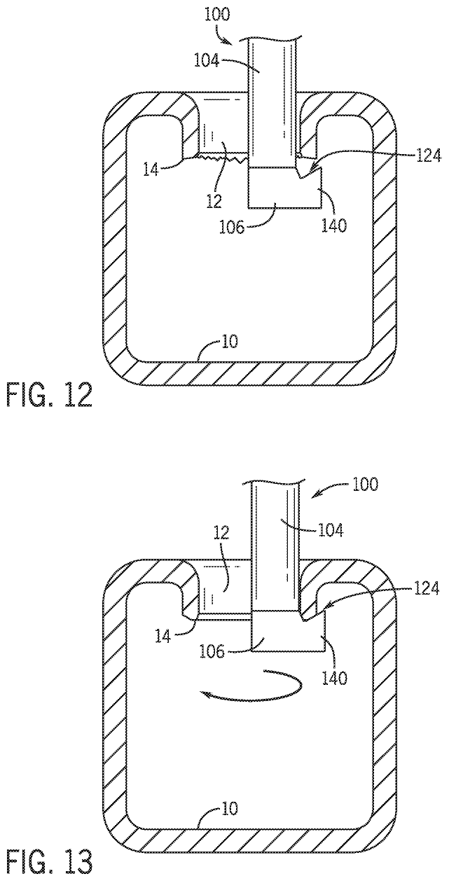

For example, with reference to FIGS. 9 through 13, some embodiments of the invention can include a method by which a distal end 14 of a bushing 12 formed in a tube 10 can be deburred. To deburr the distal end 14 of the bushing 12 formed in the tube 10 through a manufacturing method (e.g., friction drilling), with the shaft 104 and the blade body 106 outside of the tube 10, an operator uses a machine to move the deburring tool 100 in an insertion direction so that the blade body 106 and at least a portion of the shaft 104 are within the tube 10 and the blade body 106 is positioned beyond the distal end 14 of the bushing 12. The operator then moves the deburring tool 100 laterally within the bushing 12 over a lateral distance, perpendicular to the insertion direction, to position the shaft 104 adjacent an internal surface of the bushing 12 and the cutting edge 124 over/under the distal end 14 of the bushing 12. The operator then translates the deburring tool 100 in an extraction direction, opposite the insertion direction, a predetermined distance to engage the cutting edge 124 with the distal end 14 of the bushing 12. The internal diameter and circumference of the bushing 12 can then be interpolated from the lateral distance translated by the deburring tool 100 within the bushing 12, and the deburring tool 100 can be rotated within the bushing 12 along a circular path with a circumference that is smaller than the internal circumference of the bushing 12. In this manner, the deburring tool 100 removes material from the distal end 14 of the bushing 12 to define at least an external cut surface on the distal end 14 of the bushing 12. The deburring tool 100 can also define at least one of an internal cut surface, an external cut surface, or a distal cut surface on the distal end 14 of the bushing 12.

To remove the deburring tool 100 from the tube 10, the operator moves the deburring tool 100 in the insertion direction to move the blade body 106 further into the tube 10 and the cutting edge 124 beyond the distal end 14 of the bushing 12. The deburring tool 100 can then be moved laterally within the bushing 12 the lateral distance toward the center of the bushing 12 and then moved in the extraction direction to remove the deburring tool 100 from the tube 10.

Thus, embodiments of the invention can provide improved deburring of a bushing formed in a tube through a machining process (e.g., friction drilling). In some embodiments, for example, cut surfaces on the bushing can be formed, including an internal cut surface, an external cut surface, and a distal cut surface.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A deburring tool for deburring a distal end of a bushing formed within a metal tube, the deburring tool comprising:
a shaft extending along a shaft axis, the shaft having a shaft distal end and a shaft proximal end; and
a blade body extending radially outward from the shaft distal end, the blade body having a cutting edge configured to engage an external portion of the distal end of the bushing and remove material therealong.

2. The deburring tool of claim 1, wherein the deburring tool is configured to rotate within and around the bushing in a deburring direction and wherein the blade body has a forward facing blade surface and a rearward facing blade surface when moving in the deburring direction, wherein the forward facing blade surface is planar and the rearward facing blade surface is nonplanar.

3. The deburring tool of claim 1, wherein the cutting edge faces the shaft proximal end.

4. The deburring tool of claim 3, wherein the cutting edge includes an external cutting edge configured to define an external cut surface on the distal end of the bushing.

5. The deburring tool of claim 4, wherein the external cutting edge is disposed at an angle in the range of about 25 degrees to about 35 degrees from the shaft axis.

6. The deburring tool of claim 4, wherein the cutting edge includes an internal cutting edge configured to define an internal cut surface on the distal end of the bushing.

7. The deburring tool of claim 6, wherein the cutting edge has a V-shape profile.

8. The deburring tool of claim 6, wherein the internal cutting edge extends from the shaft distal end in a direction substantially away from the shaft proximal end at an angle in the range of about 20 degrees to about 30 degrees from the shaft axis.

9. The deburring tool of claim 6, wherein the cutting edge further includes a distal cutting edge between the internal cutting edge and the external cutting edge, the distal cutting edge oriented perpendicular to the shaft axis.

10. The deburring tool of claim 4, wherein the blade body extends from the shaft distal end a blade distance from a peripheral surface of the shaft to a blade distal end, the blade distance being greater than a thickness of the bushing.

11. The deburring tool of claim 10, wherein the external cutting edge extends along the cutting edge for more than half of the blade distance.

12. A deburring tool for use in a machining center for deburring a distal end of a bushing formed within a metal tube, the deburring assembly comprising:
a base configured to be received in a tool holder of the machining center;
a shaft extending from the base along a shaft axis and including a shaft distal end distal to the base and a shaft proximal end proximal to the base; and
a blade body extending radially outward from the shaft distal end, the blade body having a cutting edge configured to engage the distal end of the bushing and remove material along an external portion of the distal end to define an external cut surface.

13. The deburring tool of claim 12, wherein the cutting edge is configured to remove material along an internal portion of the distal end to define an internal cut surface, the external cut surface being larger in area than the internal surface.

14. The deburring tool of claim 13, wherein the cutting edge has a V-shape profile with an internal cutting edge and an external cutting edge.

15. The deburring tool of claim 14, wherein the internal cutting edge is disposed at an angle of about 30 degrees from the shaft axis.

16. The deburring tool of claim 15, wherein the external cutting edge is disposed at an angle of about 60 degrees from the shaft axis.

17. The deburring tool of claim 12, wherein the base, the shaft, and the blade body are integrally formed from a single piece of material.

18. A method for deburring a distal end of a bushing formed within a metal tube, the method comprising:
translating a deburring tool in an insertion direction into the bushing, the deburring tool having a shaft and a cutting edge, with an external cutting edge, extending radially outward from the shaft;
translating the deburring tool laterally, perpendicular to the insertion direction, a lateral distance within the bushing to position the shaft adjacent an internal surface of the bushing and the cutting edge over the distal end of the bushing;
translating the deburring tool in an extraction direction a predetermined distance and engaging the cutting edge with the distal end of the bushing; and
translating the deburring tool around the distal end of the bushing to remove material from an external portion thereof with the external cutting edge of the cutting edge.

19. The method of claim 18, further comprising:
interpolating the internal circumference of the bushing from the lateral distance translated by the deburring tool within the bushing.

20. The method of claim 18, wherein the cutting edge further includes an internal cutting edge configured to remove material from an internal portion of the distal end of the bushing.
